(19) United States
(12) Patent Application Publication
(10) Pub. No.: US 2006/0158045 A1
(43) Pub. Date: Jul. 20, 2006

(54) Control device with interchangeable electronic card for rolling elements such as roller blinds, roller shutters awnings and so forth

(76) Inventor: Michelangelo Speri, San Pietro in Cariano (IT)

Correspondence Address: WENDEROTH, LIND & PONACK, L.L.P., 2033 K STREET N. W., SUITE 800, WASHINGTON, DC, 20006-1021, US

(21) Appl. No.: 10/523,704

(22) PCT Filed: Aug. 5, 2003
(86) PCT No.: PCT/EP03/08699

§ 371 Date: Feb. 7, 2005

(30) Foreign Application Priority Data
Aug. 7, 2002 (IT) MI2002A001798

(51) Int. Cl. G09B 23/18

(52) U.S. Cl. 310/1

(57) ABSTRACT

A control device for rolling elements such as roller blinds, roller shutters, awnings and so forth, comprising an electric motor (2) housed inside a tubular casing (1), is fitted with an electronic control card (10) housed so that it can be extracted inside a box (7) fixed to an extremity of said tubular casing (1).

### DESCRIPTION

The present invention refers to a control device with interchangeable electronic card for rolling elements such as roller blinds, roller shutters, awnings and so forth.

On the market there are various types of control devices for rolling elements, particularly devices that comprise an electric motor housed inside a tubular casing together with an appropriate motion reduction gear, a braking device and an electronic control card. The latter often includes a radio receiver, that receives the signals emitted from ground by a radio transmitter and commands accordingly, the activation of the motor and, in some cases, the positioning of the electronic limit switches. In the latter case inside the tubular casing there is also a device for detecting the angular position of the motor shaft and, more generally, the position of the rolling element.

One problem with these control devices consists in that the access to the electronic control card, both for maintenance purposes and for purposes of replacement and/or updating, depends on the more or less complete dismounting of the device itself to extract the card from the tubular casing in which it is housed. It is evidently a complex operation that makes any intervention on the electronic control card difficult to accomplish.

Object of the present invention is to produce a control device for rolling elements of the above-mentioned type, that permits easy and rapid access to the electronic control card.

In accordance with the present invention said object is achieved with a control device for rolling elements, comprising an electric motor housed inside a tubular casing and an electronic control card for said electric motor, characterised in that said electronic control card is housed in extractable way inside a box fixed to an extremity of said tubular casing.

Every time an intervention on the electronic control card is required, either for maintenance or for updating or replacement, all that has to be done is to open the box that contains it, to extract the card and to place the same card again or another in the box.

This extractable card control system can be made compatible with a wide range of control devices with electric motor housed in a tubular casing (also called “tubular motor”) and can operate the actuation controls of the motor and the regulation and continuous control of the limit switches.

The card can provide inputs for commands via cable, via radio, via infrared and via bus connection and can be configured in various ways in function of the work modalities and the way of receiving the commands.

The input commands can be given through control devices for the operation of the tubular motor. These devices can be normal command pushbuttons, pushbuttons of a radio remote control or external sensors used in the controls for wind, sun and rain protection for awnings and rolling elements.

Its direct power supply can even be provided by 230 Vac/50 Hz lines, 110 Vac/60 Hz lines or by lines in direct current at 12/24 Vdc.

The characteristics of the present invention will be made more evident by the following detailed description of an embodiment thereof illustrated as non-limiting example in the enclosed drawings, in which:

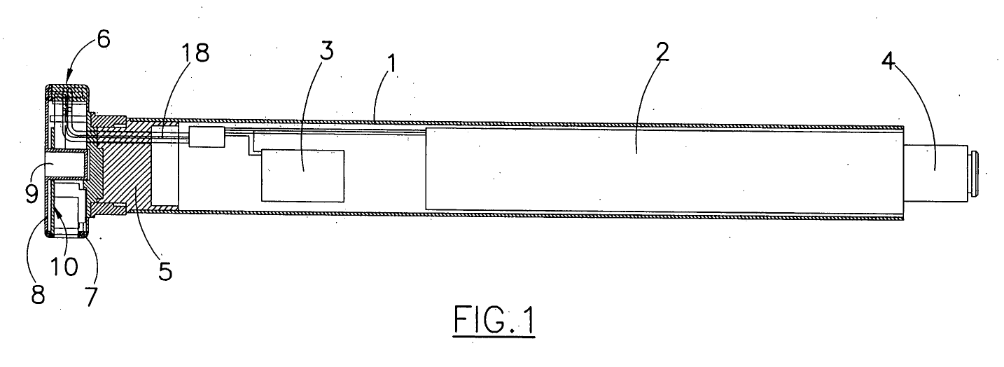

FIG. 1 shows schematically in a longitudinal section the array of an example of extractable card control device in accordance with the present invention;

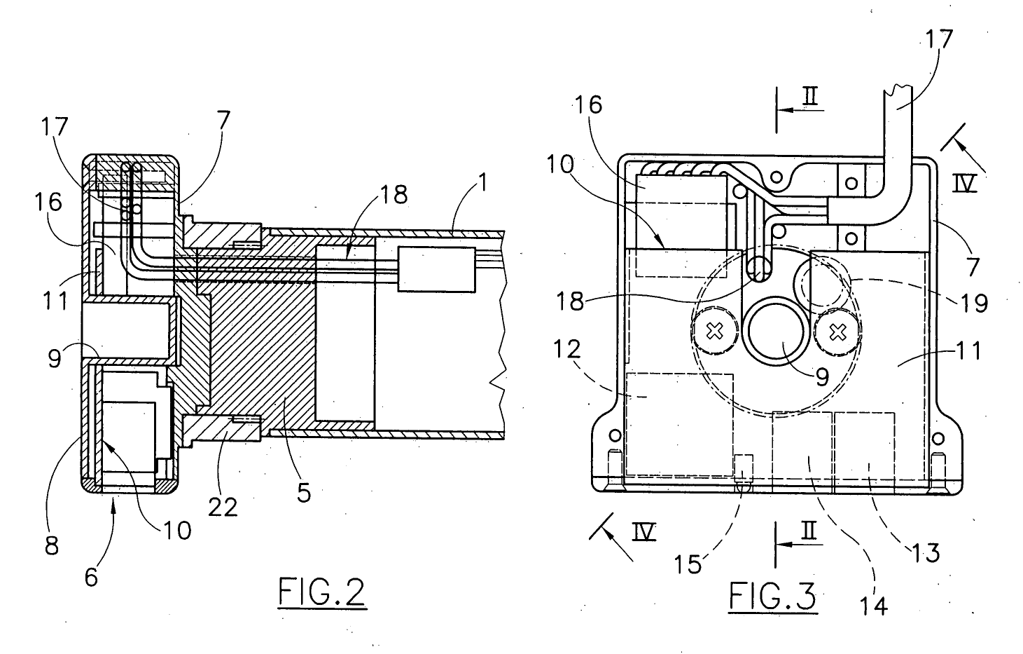

FIG. 2 shows in enlarged scale, sectioned according to line II-II of FIG. 3, an extremity head of the above-mentioned control device, comprising a box for containing an electronic control card housed therein in extractable way;

FIG. 3 shows said head seen from the left in relation to FIG. 2 with a covering element removed to show the inside of the head itself,

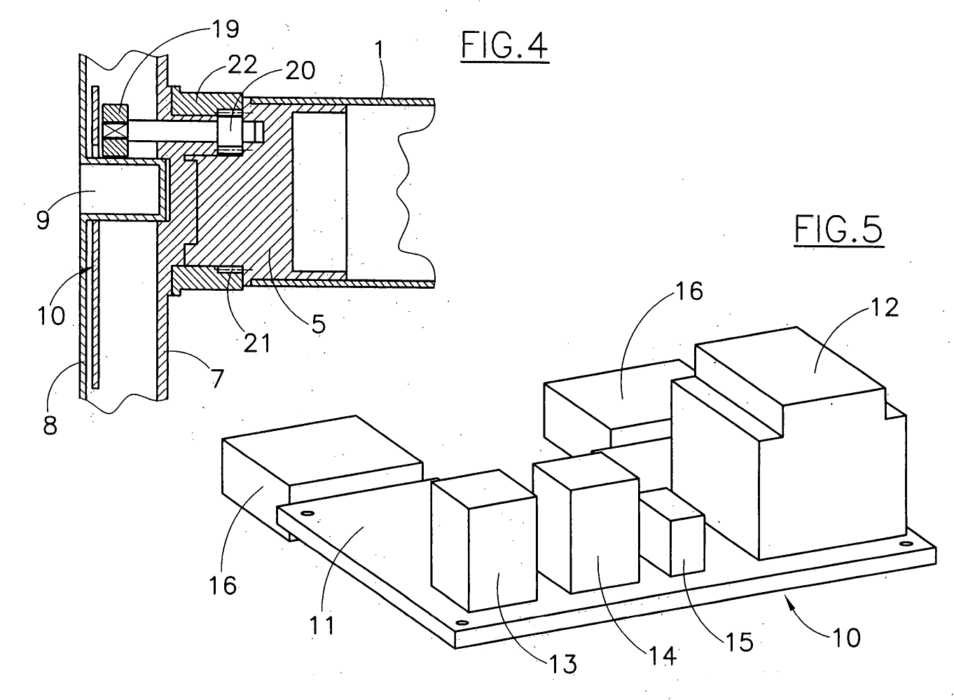

FIG. 4 shows said head seen in section according to the line IV-IV of FIG. 3;

FIG. 5 shows in schematic perspective view the array of the electronic control card.

FIG. 1 shows as an example an electronic control device according to the present invention, that basically comprises a tubular casing 1, inside which a motor group 2 is positioned composed, in an usual manner, of an electric motor with motion reduction gear and brake (components not shown in detail in the drawing). A capacitor 3 is also housed inside the tubular casing 1.

An output shaft 4 of the motor group 2, which extends from one extremity (right looking at FIG. 1) of the tubular casing 1, commands, by suitable means known per se and not shown in the drawing, the rotation of a supporting tube of the rolling element, which is positioned coaxially around the tubular casing 1 and is not shown either in the drawing.

A hub 5, to which is fixed a head 6 composed of a box 7 fitted with removable cover 8 with a central centering cavity 9 (FIGS. 2 and 3) extends instead integrally from the other extremity (left looking at FIG. 1) of the tubular casing 1.

The box 7 with relative cover 8 acts as a container for an electronic control card 10 housed inside the container itself so that it can be extracted.

An example of electronic card 10 is shown in FIG. 5 and comprises a printed circuit board 11, made in a U-shape, to which are fixed appropriate circuit components schematically indicated with the reference numbers 12-15, such as a transformer, a microprocessor, a radio receiver, a connector for bus, relays and others according to the foreseen functions, the command signals used and so forth.

A terminal board 16 fixed to the box 7 is positioned so as to receive suitable connection pins (not shown) extending from the board 11 and thus making the electric connection between the components of the electronic card 10 and, on one side, an electrical supply cable 17 coming from outside the head 6 (FIG. 3) and, on the other side, electrical supply cables 18 for the motor group 2 (FIGS. 1-3).

Inside the head 6, near the electronic card 10, an encoder 19 is also positioned, for example of the Hall effect type, which through a pinion 20 and a crown wheel 21 (FIG. 4) detects the angular position of a sleeve 22 integral with the support tube of the rolling element and duly communicate it to a suitable component of the electronic control card 10. The encoder, known per se, permits the remote electronic regulation of the limit switches of the rolling element.

The encoder 19 can be made through a linear or rotative potentiometer (variable resistance), which is capable of detecting the position of the rolling element. The encoder 19, represented here inside the box 7, can also be positioned inside the tubular casing 1.

For the maintenance of the electronic card 10 or for its replacement or for other reasons all that has to be done is to remove the cover 8 and to extract the card from the box 7 that contains it. When the maintenance or replacement has been done, the card 10 is repositioned and the cover 8 brought back into a position closing the box 7.

As can be seen, the rest of the control device, and particularly everything that is inside the tubular casing 1, is not touched.

1. Control device for rolling elements such as roller blinds, roller shutters, awnings and so forth, comprising an electric motor (2) housed inside a tubular casing (1) and an electronic control card (10) for said electric motor (2), wherein said electronic control card (10) is housed in extractable way inside a box (7) fixed to an extremity of said tubular casing (1).

2. Control device according to claim 1, wherein said box (7) is fitted with a removable cover (8).

3. Control device according to claim 1, wherein said electronic control card (10) can be connected to a terminal board (16) to which are connected an electrical supply cable (17) coming from outside the box (7) and electrical supply cables (18) for said electric motor (2).

4. Control device according to claim 1, wherein said electronic control card (10) is associated an encoder (19) for detecting the position of the rolling element.

5. Control device according to claim 1, wherein said electronic control card (10) can be connected to a terminal board (16) to which are connected an electrical supply cable (17) coming from outside the box (7) and electrical supply cables (18) for said electric motor (2).
